(19) United States
(12) Patent Application Publication
(10) Pub. No.: US 2007/0252105 A1
(43) Pub. Date: Nov. 1, 2007

(54) Heat conductor

(76) Inventors: Michael Metzke, Barleben (DE); Stefan Heyer, Magdeburg (DE)

Correspondence Address: Law Office of Karl Hormann, P.O. Box 381516, Cambridge, MA, 02238-1516, US

(21) Appl. No.: 11/799,405

(22) Filed: Apr. 30, 2007

(30) Foreign Application Priority Data
Apr. 29, 2006 (DE) 10 2006 020 584.7

(51) Int. Cl. C09K 3/18

(52) U.S. Cl. 252/70

(57) ABSTRACT

A heat conductive substance having a melting point below 160° C. and constituted by a first component selectively changeable between first and second aggregate states and made from one of an alloy of a plurality of metals and pure metal and having associated therewith a second compound comprising at least one metal other than and inert with respect to the plurality of metals and pure metal of the first compound when in its first aggregate state with the second compound readily forming a third compound with the first compound in its aggregate second state, the third compound differing in its physical and chemical properties and in its melting point from the physical and chemical properties and melting point of the first and second components.

### BACKGROUND OF THE INVENTION

1. Field of the Invention

The invention, in general, relates to a novel heat conductor and, more particularly, to a heat conductor or soldering compound consisting of multiple initially separate inert components the melting points of which differ from each other and which readily form an alloy of a melting point different from the melting point of the individual components. The invention also relates to a method of making such a compound.

2. The Prior Art

Aside from being useful in the electric and electronic industries, the compound and the method by which it is made are also useful for cooling mechanical structures subject to exposure to high levels of heat, such as engines and motors. The compound may also be used as a soldering compound for connecting mechanical, electrical and/or electronic components.

It is well known that certain electrical, electronic and mechanical apparatus and components thereof in their operation generate significant levels of heat which must be dissipated by suitable cooling devices. Sometimes, the cooling devices are connected to the components, as intimately as possible, by heat conducting pastes or pads, that is to say that they serve to avoid voids between the components and their cooling devices which would adversely interfere with the conduction and dissipation of the generated heat.

Accordingly, such heat conducting pastes and pads must satisfy such requirements and properties as high a heat conduction or transfer coefficient as possible, liquid or pasty consistency for an optimum adaptation to the shape and contour of the facing surfaces of the components and their cooling devices, chemical and physical compatibility of their individual components with each other and with the surfaces to which are applied in order to prevent undesired interactions such as chemical reactions and alloy formation, and, last but not least, toxicological neutrality.

Various metallic alloys are known as soldering compounds. They have clearly defined melting points which remain substantially the same before and after their application.

Accordingly, they suffer from certain drawbacks, at least in certain circumstances. While, on the one hand, their melting points should be as low as possible to facilitate their application and to relate to the likely limited thermal stability, especially of electronic components, their melting points should, on the other hand, be as high as possible to provide for soldered connection which are both thermally resistant and strong. Of course, these requirements oppose each other. Accordingly, these known soldering compounds of identical melting points prior to and after their application, can at best constitute no more than a compromise.

The heat conducting pastes referred to supra consist of a matrix material and a powdered substance distributed and dispersed in the matrix. The matrix material may be silicon or another non-metallic material; and the powered substance usually is either a metal, carbon (graphite) or metal oxide. Unfortunately, since these pastes always contain non-metallic substances, their performance as heat conductors is rather poor in view of the fact that their thermal conductivity is in the range from about 0.5 W/mK to no more than 10 W/mK.

Metallic matrix materials consisting of gallium or gallium alloyed with indium, tin or zinc have also become known as heat conductive materials. Other materials such as metal powders and/or carbon of good heat conductive properties and which do not form alloys with the matrix material may be suspended in the matrix.

However, the disadvantage of such heat conducting pastes is that in their liquid aggregate state they are exceedingly corrosive when applied to a light metal. More particularly, they quickly form alloys with aluminum, and the resultant gallium-aluminum alloy is subject to rapid chemical decomposition when exposed to humidity. Their decomposition products may in turn react with other substances, and hydrogen released by such decompositions may lead to explosive or at least combustible mixtures of hydrogen and air (Ep 0 44 268 A1).

Therefore, thermal conductive compounds containing liquid gallium or gallium compositions are wholly unsuitable for use in connection with frequently and commonly used aluminum.

Heat conductive materials with a low melting point, such as indium, bismuth or tin alloys have also become known. However, they suffer from low mechanical and thermal strength. Because of the low melting point of such alloys and because of the heat dispersed by the components to be cooled, the use of heat conductive layers made from such alloys results in their constantly changing between their liquid and solid aggregate states. They are also highly susceptible to oxidation from the oxygen contained in the air.

Heat conductive pads made from thermoplastic heat conductive films or foils of a low thermal conductivity not higher than about 10 W/mK have also become known.

Heat conductive films made from such metals as copper, silver or gold have become known as well. While their thermal conductivity is high, they are too hard or rigid to adapt in an optimum fashion to the shape of the surfaces of materials between which a heat bridge is to be established.

The use of such films often leads to the formation of microscopically small irregularities (surface roughness) and, in turn, to insulating air pockets on both sides of the film. Therefore, the results obtained by using such films are usually worse than if no thermal conductor were used at all in view of the fact that they form two air cushions rather than only one.

Heat conductive films or foils made of indium are also known. In order to prevent the effect described above (air pockets) it is necessary to inject this rather soft metal under high pressure between a component to be cooled and its cooling device. This, of course, is technologically rather complex. Moreover, many electrical and electronic components are unsuited for being subjected to the requisite high pressure injection.

### OBJECTS OF THE INVENTION

Accordingly, it is an object of the present invention to provide a substance and a suitable method of forming a solder connection or a heat conductive connection between an electrical, electronic or mechanical component and groups of such components which overcome the disadvantages of hitherto known substances and methods.

Other objects will in part be obvious and will in part appear hereinafter.

### BRIEF SUMMARY OF THE INVENTION

In the accomplishment of these and other objects, the invention, in one currently preferred embodiment thereof, provides for a substance useful as a soldering compound as well as a thermal conductor made up of a first component preferably having a melting point below 160° C. and second a component, the first and second components being inert with respect to each other when in a first aggregate state and forming a new substance of chemical and physical properties different from those of either the first or second component when the aggregate state of at least one of the components is changed. The first and second components, preferably are different metals, and at least one of them may be an alloy of different metals. Prior to the change, the second component may be suspended or incorporated in the first component or, alternatively, it may be separate therefrom.

The soldering compound and/or heat conductive layer, hereinafter “thermal conductor” is adapted to be interposed between electrical and/or electronic and/or mechanical components or groups thereof on the one hand and cooling devices and/or cooling elements on the other hand, and it consists of at least two components which are combined or mixed during or prior to their application. Each component may consist of one or more ingredients.

The novel features which are deemed to be characteristic of the invention are set forth with particularity in the appended claims. The invention itself, however, in respect of its structure, construction, lay-out and design, as well as manufacturing techniques and technology, together with other objects and advantages thereof will be best understood from the following description of the preferred embodiments.

Component (A)

The first component, hereafter sometimes referred to as “component (A)”, consists either of a pure metal, i.e. a chemical element or of a metal alloy. The use of gallium, indium, bismuth and tin is preferred either in their pure state or as alloys of any of them. Because of their toxic properties such metals as cadmium, lead, mercury and others are substantially excluded not least in view of restrictions placed on their use by governmental regulations.

The pure metal or metal alloy may serve as a matrix material for other substances suspended therein. Suitable substances, such as, for instance, carbon, are those which either form no alloy with the matrix or can do so to a limited degree only.

In the final product, the substances which do not form alloys with the matrix material will, however, be uniformly distributed therein and have no effect on the melting point of the matrix material.

Component (B)

A second component, hereafter sometimes referred to as “component (B)” is added to component (A). Component (B) contains metals which upon melting of the pure metal or alloy of component (A) form a new metal alloy (C) of physical and chemical properties different from those of either component (A) or (B). As a rule, the melting point of the newly formed alloy (C) is higher than the melting point of the pure metal or metal alloy of component (A).

The alloy yields a higher melting point and the material will harden.

The alloy formation and the inherent increase of the melting point of the hardened alloy should take place only during or after using the soldering compound or thermal conductor. The reason for this is that the low melting point substance in accordance with the invention may be used such that the components to be joined are subjected to very low thermal stress.

Where the substance in accordance with the invention is used as a thermal conductor, the low melting point paste or pad, when changing under the influence of low heat from a solid to a liquid or pasty state, will in an optimal manner conform to the shape of the surfaces so which it is being applied. Harding takes place thereafter.

This effect can be achieved in various ways:

I. Component (A) is melted completely or partially and is mixed with component (B) shortly before or during an application. The formation of an alloy of the two components and the resultant increase of the melting point take place over a time sufficient for applying the component mixture in accordance with its purpose and prior to its hardens or curing. (See Example 1).

II. Component (A) is melted either completely or partially and is mixed with component (B). An immediate initiation of alloy formation is prevented by cooling the component mixture to a temperature below the melting point of component (A) immediately following introduction of component (B). Upon cooling, component (B) remains in component (A) in a suspended state without either forming an alloy or otherwise reacting with component (A).

An irreversible reaction between the pure metal or alloy of component (A) and component (B) (alloy formation) does not occur until after a renewed heating for some time above the melting point of the pure metal or metal alloy of component (A). The melting point is raised and the material hardens. (See Example 2).

III. Where the surface of the electrical and/or electronic and/or mechanical component to which the substance in accordance with the invention will be applied, consists of a material which readily forms an alloy with component (A), such component may serve as, or take on the role of, component (B). The second layer of a double-layered film would then be substituted by the substance of the contact surface of the structural component. (See Examples 4a, 4b and 4c).

Application

For producing a soldered connection and/or a heat conductive layer between electrical and/or electronic and/or mechanical structural elements and/or structural groups and cooling devices and/or cooling elements, the substance in accordance with the invention is initially applied to one or both surfaces between which the soldered connection is to be formed or between which heat transfer is to take place. This is accomplished by placing (in the case of a film), brushing, spraying, dipping, scattering, pouring of pressing or by any other suitable process. For forming a heat conductive coating, the substance to be applied may be applied in solid, pasty or liquid form. Thereafter, the coated surfaces are moved into contact with each other.

Where the substance was applied in a solid or pasty state (e.g. as a film, powder or paste), heating to a temperature above the melting point of the metal alloy contained in component (A) will be necessary during or following the application.

The melting of the metal alloy contained in component (A) may be carried out in various ways.

The metal alloy contained in component (A) of the substance in accordance with the invention is melted during or prior to the application by external heat, and the substance in accordance with the invention is applied to one or both surfaces between which heat transfer is to take place. Thereafter, these surfaces are placed together. (See Example 5).

The substance in accordance with the invention is applied in an unmelted state on one or both surfaces, or it is placed or otherwise disposed as a film or pad between the surfaces between which heat transfer is to take place. Shortly before, during or following placing these surfaces into abutting relationship, the metal alloy contained in component (A) of the substance in accordance with the invention is completely or partially melted by the application of external heat. The external heat may be applied by a stream of hot air, by a hot air bath, e.g. in a heat tunnel, or by direct contact of the cooling device with the heated mating component. (See Example 6.)

As a supplement or alternative to applying external heat, the structural component or component group to be cooled may be operated in order to generate the heat required to melt the metal alloy contained in component (A). (See Example 7).

### ADVANTAGES OF THE INVENTION

The advantages of the invention are that soldered connections and/or heat conductive layers made from the substance of the invention can be produced at low temperatures in a manner which does not thermally damage the components and/or component groups contacted by the substance.

Following its application and alloy formation between components (A) and (B) the melting point of the substance in accordance with the invention is raised as is the thermal stability or resistance of solder connections and/or heat conductive layers made from the substance.

The substance in accordance with the invention consists only of materials of excellent thermal conductivity. A heat conductive layer made in accordance with the invention is temporarily put into a liquid or pasty state either during or after its application. It can thus optimally adapt or conform to the shape of surfaces between which heat transfer is to take place. Air pockets which would otherwise impede or interfere with heat transfer are substantially avoided.

Compared with permanently liquid heat conductive metallic layers or layers which alternate between liquid and solid states as a result of heat loss, heat conductive layers made in accordance with the invention are of higher resistance against the oxidizing effect of the oxygen in air and they thus have a longer useful life.

Gallium-containing soldering compounds and/or heat conductive substances made in accordance with the invention, because of their rapid alloy formation with component (B) and the resultant quick hardening, may even be used on aluminum. As a result of the quick transition of the substance in accordance with the invention to its solid aggregate state, any further alloy formation with the aluminum is prevented.

Since for its transition to a molten state, the substance may be prepared in a variety of ways, i.e. as a paste, a film or in bars, the technological process of applying the substance is variable as well. For different applications, the inventive substance may, by a precise selection of its alloyed components, be targeted exactly to different required or desired melting temperatures. Owing to the very low melting points of the alloys used, the thermal stability of components to be cooled is relatively insignificant and, accordingly, the safety of applying the substance is increased.

Also, practicing the method in accordance with the invention requires no excessive pressures when mating a structural component with a cooling device.

In accordance with the invention no metals or other substances are used which because of their toxic properties are excluded from use by law or governmental regulation. Therefore, the practice of the invention is believed not to be subject to any restrictions.

The heat conductive material here described may also be packaged as a film (heat conductive pad).

### EXAMPLES

The invention will hereafter be described in greater detail with reference to examples.

### Example 1

Magnesium powder is incorporated into a liquid metallic alloy of a low melting point and consisting of indium, bismuth and tin.

The paste made in this manner is applied immediately.

After some time the magnesium will completely or at least partially form a new alloy with the original alloy. The melting point of the new alloy is higher than that of the starter materials, and the new alloy subsequently hardens.

### Example 2a

Magnesium powder is incorporated in a liquid metallic alloy of low melting point and consisting of indium, bismuth and tin.

The resultant paste made is rapidly cooled and is thereby prevented from forming an alloy with the magnesium.

The metallic alloy with the magnesium suspended therein is spread-rolled into a film.

After its application, the film melts under the effect of the heat dissipated by the structural element to be cooled. The magnesium will form an alloy with the indium, bismuth and tin alloy. The melting point of the new indium, bismuth, tin and magnesium alloy is higher than the melting point of the indium, bismuth and tin alloy. The material hardens to a quasi permanent state.

### Example 2b

Very small copper particles (nano-copper) are suspended in gallium by stirring. The suspension is rapidly cooled in order initially to prevent the formation of an alloy. The resultant suspension is formed into soldering rods or soldering wire. During processing, the soldering compound is heated once above the melting point of gallium (29.8° C.). The ensuing alloy formation causes the melting point to be raised, and the metal hardens.

### Example 3

A first layer of a film made up of two or more layers, consists of a metallic alloy melting at 59° C. and consisting of indium, bismuth and tin. This alloy may contain a suspension of other substances, preferably of good heat conducting properties, which do not form alloys.

The second layer consists of magnesium.

Only after heating above 59° C. for some time, an irreversible reaction takes place between the two layers (alloy formation). The melting point is raised, and the material hardens.

### Example 4a

A film is made from an alloy consisting of indium, bismuth and tin having a melting point of 59° C. Other substances, preferably good heat conductors, which do not form alloys, may be suspended in this alloy. The foil is placed on a contact surface of a cooling device and is melted by an external heat source or by the heat dissipated by a structural component to be cooled. The results are that an alloy is formed with the magnesium of the contact surface and that the heat conductive layer hardens.

### Example 4b

A paste consisting of a suspension of graphite in a gallium-tin alloy is brushed as a thin layer on a copper surface. The result is a gallium-copper alloy the melting point of which is significantly above the melting point of gallium. The paste hardens.

### Example 4c

Copper in a quantity not significantly affecting the melting point of a metallic alloy consisting of gallium, indium and tin is alloyed into it. The gallium, indium, tin, copper alloy is applied to a copper surface. Even a very small quantity of copper additionally alloying with the copper surface as a result of its contact therewith leads to a significant increase of the melting point and to hardening of the alloy.

### Example 5

A heat conductive material in accordance with the invention consisting of an indium-bismuth-tin alloy (component (A)) and unalloyed magnesium (component (B)) suspended therein is partially melted by external heat and applied to surfaces between which heat transfer is to take place.

### Example 6

A heat conductive material in accordance with the invention consisting of an indium-bismuth-tin alloy (component (A)) and unalloyed magnesium (component (B)) suspended therein is applied between surfaces between which heat transfer is to be optimized. The surfaces are pressed together. Thereafter one or both of the surfaces are heated by an external heat source, such as, e.g., a stream of hot air or a hot air bath (heat tunnel) or by direct contact with a heat source. Heating takes place to a temperature slightly above the melting temperature of that component of the heat conductive material which has the lowest melting point.

### Example 7

A film made of the heat conductive material is placed between surfaces between which heat transfer is to take place. The surfaces are pressed together. Up to this point in time, the still solid film could not yet optimally adapt to the surfaces between which it was positioned. Upon initial operation of the component constituted by the structural elements the temperature of the structural element to be cooled increases by dissipation of the operating temperature (heat loss) to a level above the melting point of the metal alloy contained in component (A) of the film. The alloy thus melts and the molten material optimally conforms to the surfaces. The ensuing alloy formation between components (A) and (B) causes the melting point to be raised, the heat conductive material hardens, and its thermal stability increases.

### Example 8

An alloy consisting of indium, bismuth and tin is ground into a powder and is mixed with magnesium powder. The powder mixture is either mixed into a paste of high or low viscosity with a humectant, such as, for instance, water, or it is suspended in a humectant. The paste or liquid suspension is applied to at least one of the heat conducting surfaces. It is thereafter heated until the humectant has evaporated. The heat conducting surfaces are then placed into engagement with each other and component (A) of the heat conductive agent is melted either by heat from an external heat source or from the structural elements to be cooled. The results in the formation of an alloy with component (B) and to the formation of a heat conductive layer.

What is claimed is:

1. A heat conductive substance, comprising:
a first component being changeable between first and second aggregate states and comprising one of an alloy made from a plurality of metals and a pure metal of predetermined physical and chemical properties and having a melting point below 160° C.;
at least one second compound comprising at least one metal other than a metal of the first compound with the first compound without affecting the physical and chemical properties and melting point of the first compound in one of its first and second aggregate states and affecting the physical and chemical properties of the first compound when in the other of its first and second aggregate states.

2. The heat conductive substance of claim 1, wherein in the other of the first and second aggregate states the second compound forms an alloy with the first compound.

3. The heat conductive substance of claim 2, wherein the alloy formed by the first and second compounds has a melting point higher than the melting point of the first compound.

4. The heat conductive substance of claim 1, wherein the first compound comprises an alloy selected from the group consisting of indium, bismuth, zinc and gallium.

5. The heat conductive substance of claim 4, wherein the melting point of the fist compound is 59° C.

6. The heat conductive substance of claim 1, wherein the pure metal is gallium.

7. The heat conductive substance of claim 1, wherein the second compound is selected from the group consisting of magnesium and copper.

8. The heat conductive substance of claim 1, wherein the second component is suspended in the first component.

9. The heat conductive substance of claim 1, wherein the first and second components are provided as physically separate sheets.

10. The heat conductive substance of claim 1, wherein the first component is an alloy selected from the group consisting of copper and gallium having graphite suspended therein.

11. A heat conductive substance having a melting point below 160° C. and comprising a first component selectively changeable between first and second aggregate states and made from one of an alloy of a plurality of metals and pure metal and having associated therewith a second compound comprising at least one metal other than and inert with respect to the plurality of metals and pure metal of the first compound when in its first aggregate state, wherein the second component is such as easily to form an alloy with the first compound when in its second aggregate state.

12. The heat conductive substance of claim 11, wherein in its second aggregate state the first component is molten by being heated to a temperature above its melting point.

13. The heat conductive substance of claim 12, wherein the alloy formed from the first and second components constitutes a third component differing in its physical and chemical properties from those of the first component.

14. The heat conductive substance of claim 13, wherein the formation of the alloy is initially prevented by rapid cooling below the melting point of the first component.

15. The heat conductive substance of claim 11, wherein the first component comprises at least one metal selected from the group consisting of gallium, indium, bismuth and tin.

16. The heat conductive substance of claim 11, wherein the second component comprises a metal selected from the group consisting of magnesium and copper.

17. The heat conductive substance of claim 11, wherein carbon is suspended in the first component.

18. The heat conductive substance of claim 11, wherein the alloy formed by the first and second components possesses physical and chemical properties different from those of the first and second components.

19. The heat conductive substance of claim 11, wherein one of the first and second components is suspended in the other of the first and second components.

20. The heat conductive substance of claim 11, wherein the first and second components are physically separate from each other.
